(19) United States
(12) Patent Application Publication
(10) Pub. No.: US 2019/0353127 A1
(43) Pub. Date: Nov. 21, 2019

(54) FUEL INJECTOR AND RELATED DEVICES

(71) Applicant: Scania CV AB, Södertälje (SE)

(72) Inventors: Raoul ILIA, Södertälje (SE); Carl-Johan CEDERBERG, Stockholm (SE); Andreas ANDERSSON, Södertälje (SE); Kim KYLSTRÖM, Tullinge (SE)

(73) Assignee: Scania CV AB, Södertälje (SE)

(21) Appl. No.: 16/470,015

(22) PCT Filed: Dec. 5, 2017
(86) PCT No.: PCT/SE2017/051216

§ 371 Date: Jun. 14, 2019

(30) Foreign Application Priority Data
Dec. 22, 2016 (SE) 1651715-3

(51) Int. Cl. F02M 61/16; F02M 47/00; F02M 55/00; F02M 61/10; B05B 1/30; B05B 15/18

(52) U.S. Cl. CPC F02M 61/168; F02M 47/00; F02M 55/008; F02M 61/20; B05B 1/3046; B05B 15/18; F02M 61/10

(57) ABSTRACT

The present disclosure relates to a fuel injector for supplying fuel into a combustion chamber of an internal combustion engine. The fuel injector comprises an injector body, a nozzle, a needle, and a nozzle retainer removably arranged at the injector body to retain the nozzle against the injector body. The nozzle comprises a first channel adapted to contain fuel. The injector body comprises a second channel adapted to contain fuel. The first and second channels are fluidically connected. The needle is slidably arranged in the first and second channels. The needle comprises an upper needle section and a lower needle section. The lower needle section is removably connected to the upper needle section. The present disclosure also relates to a nozzle for a fuel injector, a lower needle section for a fuel injector, and an internal combustion engine comprising a fuel injector.

### CROSS-REFERENCE TO RELATED APPLICATIONS

This application is a national stage application (filed under 35 § U.S.C. 371) of PCT/SE2017/051216, filed Dec. 5, 2017 of the same title, which, in turn, claims priority to Swedish Application No. 1651715-3 filed Dec. 22, 2016; the contents of each of which are hereby incorporated by reference.

### FIELD OF THE INVENTION

The present invention relates to a fuel injector for supplying fuel into a combustion chamber of an internal combustion engine, a nozzle for a fuel injector, a lower needle section for a fuel injector, and an internal combustion engine comprising at least one combustion chamber and a fuel injector.

### BACKGROUND

A fuel injector is a device used for supplying fuel into a combustion chamber of an internal combustion engine. Compression ignition engines, such as diesel engines, and some spark ignition engines, such as petrol engines, use a fuel injector for supplying fuel directly into a combustion chamber. Petrol engines having a fuel injector for supplying fuel directly into a combustion chamber are usually referred to as gasoline direct injection engines. In diesel engines, the injected fuel is ignited by compression heat, or by a glow plug. In petrol engines, the injected fuel is ignited by a spark of a spark plug. Development of fuel injectors have led to high injection pressures of the fuel which is advantageous for reducing exhaust emissions from the engine, such as formation of soot. In addition, for compression ignition engines, fuel injectors have been developed capable of performing several injections during a combustion cycle, which imposes demands on the design of the fuel injector.

During running of a combustion engine, a fuel injector is subjected to a lot of vibrations and heat since the fuel injector is mounted at a cylinder head of the combustion engine with at least a tip of the injector being exposed to the environment within the combustion chamber. Further, modern fuel injectors are subjected to considerable higher fuel pressures than older fuel injectors. A fuel injector for supplying fuel into a combustion chamber of an internal combustion engine usually comprises a needle and a nozzle comprising a needle seat portion, where the needle cooperates with the needle seat portion to control the injection of fuel. For all kind of engines using at least one fuel injector for supplying fuel into a combustion chamber, the fuel injector is a vital component of the engine. Wear or malfunction of an injector will lead to deterioration of emission values and poor engine performance.

Thus, it is important that a fuel injector is reliable, can withstand high fuel pressures and it is an advantage if the fuel injector is easy to maintain, especially injectors for heavy duty vehicles since such injectors usually operate at lot of hours during their lifetime.

### SUMMARY OF THE INVENTION

It is an object of the present invention to provide a fuel injector having conditions for operating with high fuel pressures while being simple to maintain.

According to an aspect of the invention, the object is achieved by a fuel injector for supplying fuel into a combustion chamber of an internal combustion engine. The fuel injector comprises an injector body, a nozzle, a needle comprising a needle tip at a first end of the needle, and a nozzle retainer removably arranged at the injector body to retain the nozzle against the injector body. The nozzle comprises a first channel adapted to contain fuel, nozzle openings extending from the first channel, and a seat portion adjacent to the nozzle openings. The injector body comprises a second channel adapted to contain fuel, wherein the first and second channels are fluidically connected. The needle is slidably arranged in the first and second channels, between a first position, in which the needle tip abuts the seat portion to close a fluid connection between the first channel and the nozzle openings, and a second position in which the needle tip is released from the seat portion to open the fluid connection between the first channel and the nozzle openings. The needle comprises an upper needle section and a lower needle section, wherein the lower needle section comprises the needle tip. The lower needle section is removably connected to the upper needle section.

Since the lower needle section is removably connected to the upper needle section and since the nozzle retainer is removably arranged at the injector body to retain the nozzle against the injector body, the nozzle as well as the lower needle section can easily be removed from the injector body and can easily be replaced by a new nozzle and a new lower needle section. Accordingly, a fuel injector is provided being simple to maintain.

Further, since the first channel of the nozzle and the second channel of the injector body are fluidically connected and since the needle is slidably arranged in the first and second channels, the need for sealing surfaces which seal against leakages along the needle is circumvented. Thus, a fuel injector is provided having conditions for operating with high fuel pressures.

Accordingly, the above-mentioned object is achieved.

Further, since the need for sealing surfaces which seal against leakages along the needle is circumvented, a reliable fuel injector is provided.

Optionally, the lower needle section is connected to the upper needle section in at least one of the first and second channels. Since both the first channel and the second channel are adapted to contain fuel, in these embodiments, the lower needle section is connected to the upper needle section in a channel adapted to contain fuel. As a result, the need for a sealing surface for sealing the surface of the connection between the lower needle section and the upper needle section is circumvented. Further, since the need for a sealing surface is circumvented, friction during movement of the needle can be maintained low. As a further result of these features, reliability of the fuel injector is improved.

Optionally, the fuel injector further comprises a control chamber adapted to contain fuel, wherein a second end of the needle is in fluid communication with the control chamber, and wherein movement of the needle between the first and second positions is controlled by controlling a pressure difference between fuel pressure in the control chamber and fuel pressure in the first and second channels. Due to these features, forces acting on the lower needle section may displace the needle from the second position to the first position and forces acting on the upper needle section may displace the needle from the first position to the second position. Thereby, during operation of the fuel injector, no separation force will arise between the upper needle section and the lower needle section. As a result, the connection between the upper needle section and the lower needle section can be ensured. Further, due to these features, requirements of the connection between the upper needle section and the lower needle section is reduced. For example, the connection between the upper and lower needle sections can be provided without any cohesive forces holding the upper and lower needle sections together in an axial direction of the needle.

Optionally, the second end of the needle forms a delimiting surface of the control chamber. Thereby, a simple and reliable control of movement is provided of the needle between the first and second position.

The injector body is provided with at least one stop portion extending into the second channel, and wherein the upper needle section comprises one or more protrusions protruding in a radial direction of the upper needle section, wherein the one or more protrusions are arranged to abut against the at least one stop portion, to prevent movement of the upper needle section out of the second channel, when the nozzle retainer and the nozzle are removed from the injector body. Thereby, a fuel injector is provided in which the upper needle section is retained in the second channel in a simple and effective manner, even when the nozzle retainer and the nozzle are removed from the injector body. As a result, removal of the lower needle section, as well as attachment of a new lower needle section, is facilitated. Thus, according to these features, maintenance of the fuel injector is further simplified.

Optionally, the at least one stop portion is provided with at least one gap forming a fluid connection for fuel. Thereby, the at least one stop portion of the injector body provide a flow path for fuel past the at least one stop portion.

Optionally, the first and second channels are fluidically connected via the at least one gap. Since the injector body comprises the first channel, the nozzle comprises the second channel and the first and second channels are fluidically connected via the at least one gap, the at least one stop portion provided with at least one gap may be arranged in a region of a boundary between the first and second channels. Thereby, when the nozzle retainer and the nozzle are removed from the injector body, the one or more protrusions may abut against the at least one stop portion to prevent movement of the upper needle section out of the second channel, in a region of an end surface of the injector body. Thereby, access to a connection portion of the upper needle section is facilitated. Further, removal of the lower needle section, as well as attachment of a new lower needle section onto the upper needle section, is facilitated.

Optionally, the injector body is provided with at least two stop portions and at least two gaps provided between the at least two stop portions. Thereby, retaining of the upper needle section in the second channel is ensured, while a sufficient flow path past the at least two stop portions is ensured.

Optionally, the upper needle section comprises two or more protrusions, and wherein the at least one stop portion is provided with an extension around a circumference of the second channel exceeding a circumferential distance between edges of the two or more protrusions. Thereby, the upper needle section is prevented from being displaced out of the injector body independent of a rotational position of the upper needle section in relation to the injector body.

Optionally, the fuel injector is a common rail fuel injector and wherein the second channel is arranged to be fluidically connected to a pressurized fuel rail of a common rail fuel injection system. Thereby, a common rail fuel injector is provided having conditions for operating with high fuel pressures while being simple to maintain.

Optionally, the fuel injector comprises an actuator arranged to displace the needle between the first and the second position, and/or between second and first position. Thereby, a fuel injector comprising an actuator arranged to displace the needle between the first and the second position, and/or between second and first position, is provided having conditions for operating with high fuel pressures while being simple to maintain.

A further object of the present invention is to provide a device providing conditions for a simple maintenance of a fuel injector being capable of operating with high fuel pressures. According to a further aspect of the invention, the object is achieved by a nozzle for a fuel injector according to some embodiments of above. Thus, a nozzle is provided which provides conditions for a simple maintenance of the fuel injector, since the nozzle forms a replacement part, which can be used to replace a damaged nozzle of a fuel injector simply by removing the nozzle retainer which retains the damaged nozzle and remove the damaged nozzle from the injector body, and attach the nozzle provided onto the injector body and retain the nozzle against the injector body using the nozzle retainer. Since the nozzle comprises the first channel adapted to contain fuel and the first channel is adapted to be in fluid connection with the second channel of an injector body, the need for sealing surfaces against the needle of the fuel injector is circumvented.

Thus, a device is provided which provides conditions for a simple maintenance of a fuel injector being capable of operating with high fuel pressures. As a result, the above mentioned further object is achieved.

According to a still further aspect of the invention, the further object is achieved by a lower needle section for a fuel injector according to some embodiments of above. Thereby, a lower needle section is provided which provides conditions for a simple maintenance of the fuel injector, since the lower needle section forms a replacement part, which can be used to replace a damaged lower needle section of a fuel injector in a simple manner, i.e. simply by removing a damaged lower needle section and connecting the lower needle section provided onto the upper needle section of the injector, when the nozzle retainer and the nozzle is removed from the injector body. Since the needle is slidably arranged in the first and second channels of the injector, the need for a sealing surfaces against the needle of the injector is circumvented.

Thus, a device is provided which provides conditions for a simple maintenance of a fuel injector being capable of operating with high fuel pressures. As a result, the above mentioned further object is achieved.

According to a still further aspect of the invention, the object is achieved by an internal combustion engine comprising at least one combustion chamber and a fuel injector according to some embodiments of above, wherein the fuel injector is configured to supply fuel into the combustion chamber. Since the internal combustion engine comprises a fuel injector according to some embodiments of above, a device is provided which provides conditions for a simple maintenance of a fuel injector being capable of operating with high fuel pressures. As a result, the above mentioned further object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a cross section of a fuel injector,

FIG. 2 illustrates a second cross section of the fuel injector illustrated in FIG. 1,

FIG. 3 illustrates a fuel injector according to some further embodiments, and

FIG. 4 illustrates an internal combustion engine comprising a combustion chamber and a fuel injector according to some embodiments.

### DETAILED DESCRIPTION

Aspects of the present invention will now be described more fully. Like numbers refer to like elements throughout. Well-known functions or constructions will not necessarily be described in detail for brevity and/or clarity.

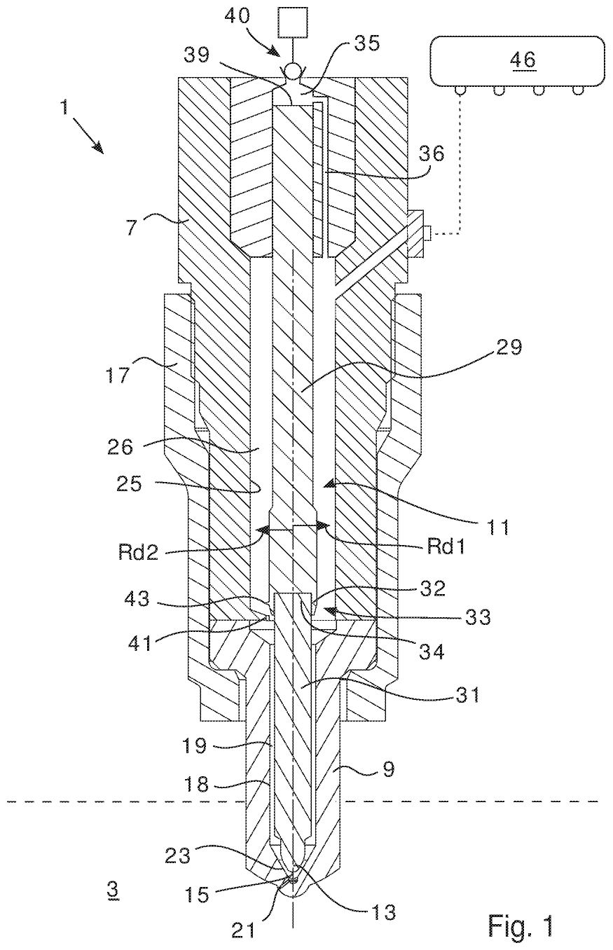

FIG. 1 illustrates a cross section of a fuel injector 1 for supplying fuel into a combustion chamber 3 of an internal combustion engine. The fuel injector 1 may be configured to supply fuel into a combustion chamber 3 of a compression-ignition engine such as a diesel engine. According to further embodiments, fuel injector 1 is configured to supply fuel into a combustion chamber 3 of a spark-ignition engine. The fuel injector 1 comprises an injector body 7, a nozzle 9, a needle 11 comprising a needle tip 13 at a first end 15 of the needle 11, and a nozzle retainer 17 removably arranged at the injector body 7 to retain the nozzle 9 against the injector body 7. The nozzle retainer 17 and the injector body 7 may each comprise threads forming a removable connection between the nozzle retainer 17 and the injector body 7.

The nozzle 9 comprises a first channel 19 adapted to contain fuel, and nozzle openings 21 extending from the first channel 19. The nozzle 9 further comprises a seat portion 23 adjacent to the nozzle openings 21. The injector body 7 comprises a second channel 26 adapted to contain fuel, wherein the first and second channels 19, 26 are fluidically connected. The needle 11 is slidably arranged in the first and second channels 19, 26 between a first position, in which the needle tip 13 abuts the seat portion 23 to close a fluid connection between the first channel 19 and the nozzle openings 21, and a second position in which the needle tip 13 is released from the seat portion 23 to open the fluid connection between the first channel 19 and the nozzle openings 21. In FIG. 1 the needle 11 is illustrated in the second position. The needle 11 comprises an upper needle section 29 and a lower needle section 31. The lower needle section 31 comprises the needle tip 13. The lower needle section 31 is removably connected to the upper needle section 29.

Thereby, a fuel injector 1 is provided which can be maintained in a simple and cost-efficient manner. The portion of a fuel injector needle comprising the needle tip 13 and the nozzle 9 are parts of a fuel injector especially subjected to wear and tear. However, according to the embodiments illustrated, maintenance of the fuel injector 1 provided can be performed simply by removing the nozzle retainer 17 which retains a worn nozzle and remove the worn nozzle from the injector body 7. Then, a worn lower needle section 31 can be removed from the upper needle section 29 and be replaced by a new lower needle section by connecting the new lower needle section onto the upper needle section 29. Then, a new nozzle can be retained to the nozzle body 7 using the same nozzle retainer 17.

Accordingly, a fuel injector 1 is provided which can be maintained in a simple and cost-efficient manner, and instead of discarding the entire fuel injector 1, a worn lower needle section 31 comprising the needle tip 13, and a worn nozzle 9 can easily be replaced.

According to the embodiments illustrated in FIG. 1, the lower needle section 31 is removably connected to the upper needle section 29 in a connection 33, wherein the connection 33 comprises a connection portion 32 of the upper needle section 29 and a connection portion 34 of the lower needle section 31. The connection portion 34 of the lower needle section 31 comprises surfaces of an upper portion of the lower needle section 31 and the connection portion 32 of the upper needle section 29 comprises a cylindrical aperture having a diameter essentially corresponding to a diameter of the connection portion 34 of the lower needle section 31. Thereby, the connection portion 34 of the lower needle section 31 can easily be removed from, and inserted into, the cylindrical aperture of the connection portion 32 of the upper needle section 29. The connection portion 34 of the lower needle section 31 and the connection portion 32 of the upper needle section 29 may be provided with sufficiently accurate tolerances such that the surfaces of the connection portion 34 of the lower needle section 31 and the surfaces of the connection portion 32 of the upper needle section 29 adhere to form a gauge block connection and/or wringing area.

According to the embodiments illustrated in FIG. 1, a major portion of the upper needle section 29 extends through the second channel 26. Further, according to these embodiments, the lower needle section 31 is connected to the upper needle section 29 in the second channel 26 adjacent to a boundary between the first and second channels 19, 26. Thereby, easy access is provided to the connection between the lower needle section 31 and the upper needle section 29, when the nozzle retainer 17 and the nozzle 9 are removed from the injector body 7. Further, when the nozzle retainer 17, the nozzle 9 and the lower needle section 31 are removed from the injector body 7, the connecting portion 32 of the upper needle section 29 will be visible to a user which facilitates connection of a lower needle section 31 into the connecting portion 32 of the upper needle section 29.

According to the embodiments illustrated in FIG. 1, the fuel injector 1 is a common rail fuel injector and the second channel 26 is arranged to be fluidically connected to a pressurized fuel rail 46 of a common rail fuel injection system. Fuel pressure in the pressurized fuel rail 46, and thus also in the second channel 26, may for example be above 1000 bar. Since, the nozzle 9 comprises the first channel 19 adapted to contain fuel and the first channel 19 is in fluid connection with the second channel 26 of the injector body 7, the need for sealing surfaces against the needle 11 is reduced, and a fuel injector 1 is provided having conditions for operating with high fuel pressures.

According to the illustrated embodiments, the fuel injector 1 comprises a control chamber 35 adapted to contain fuel. A second end 39 of the needle 11 is in fluid communication with the control chamber 35. The second end 39 of the needle 11 is opposite to the first end 15 of the needle 11. Further, the second end 39 of the needle 11 is an end of the upper needle section 29 and the second end 39 of the needle 11 forms a delimiting surface of the control chamber 35. The control chamber 35 is in fluid communication with the second channel 26 via connection channel 36. Movement of the needle 11 between the first and second positions is controlled by controlling a pressure difference between fuel pressure in the control chamber 35 and fuel pressure in the first and second channels 19, 26. The pressure difference between fuel pressure in the control chamber 35 and fuel pressure in the first and second channels 19, 26 may be controlled by controlling fuel pressure in the control chamber 35. The fuel pressure in the control chamber 35 may be controlled using a valve 40. According to further embodiments, fuel pressure in the control chamber 35 is controlled using an actuator (not shown).

When the valve 40 illustrated in FIG. 1 opens, fuel pressure in the control chamber 35 is significantly reduced. The connection channel 36 is provided with at least a portion having a small cross sectional area which restricts flow of fuel from the second channel 26 to the control chamber 35 when the valve 40 is opened. As a result, a pressure difference is obtained between fuel pressure in the control chamber 35 and in the first and second channels 19, 26. No restriction of flow of fuel is provided between the first and second channels 19, 26. Therefore, the fuel pressure in the first and second channels 19, 26 are essentially the same during operation of the fuel injector. When the valve 40 opens, the higher fuel pressure in the first and second channels 19, 26 acting on portions of the needle 11, moves the needle 11 from the first position to the second position in which the needle tip 13 is released from the seat portion 23 to open the fluid connection between the first channel 19 and the nozzle openings 21. When the valve 40 closes, fuel pressure rises in the control chamber 35 due to the flow of fuel from the second channel 26 to the control channel 35. As a result, the force of the fuel pressure in the control chamber 35 acting on the second end 39 of the needle 11 will exceed the forces of the fuel pressure in the first and second channels 19, 26 acting on portions of the needle 11. Thereby, the needle 11 will move from the second position to the first position, in which the needle tip 13 abuts the seat portion 23 to close the fluid connection between the first channel 19 and the nozzle openings 21.

Thus, according to these embodiments, forces acting on the lower needle section 31 will displace the needle 11 from the second position to the first position and forces acting on the upper needle section 29 will displace the needle 11 from the first position to the second position. Accordingly, upon displacement of the needle from the first position to the second position, the lower needle section 31 will exert a pushing force onto the upper needle section 29 via the connection 33. Likewise, upon displacement of the needle from the second position to the first position, the upper needle section 29 will exert a pushing force onto the lower needle section 31 via the connection 33. Accordingly, during operation of the fuel injector 1, according to these embodiments, no separation force will arise between the upper needle section 29 and the lower needle section 31. As a result, the connection between the upper needle section 29 and the lower needle section 31 is ensured. Further, due to these features, the requirements of the connection 33 between the upper needle section 29 and the lower needle section 31 is reduced. Thus, the connection 33 may be made such that the lower needle section 31 is held to the upper needle section 29 in radial directions of the needle 11 and made such that the lower needle section 31 and the upper needle section 29 can apply forces onto each other, but without any cohesive forces holding them together. Instead, in such embodiments, a force between the needle tip 13 of the lower needle section 31 and the seat portion 23 of the nozzle 9 will ensure connection between the upper and lower needle sections 29, 31 when the nozzle 9 is retained against the injector body 7 using the nozzle retainer 17 and when the injector 1 does not operate. As mentioned above, during operation, fuel pressure acting onto the upper and lower needle sections 29, 31 will ensure connection between the upper and lower needle sections during operation of the fuel injector 1. The cylindrical aperture of the connection portion 32 of the upper needle section 29 may be provided with an extension in an axial direction of the upper needle section 29 exceeding a stroke distance of the needle 11, i.e. a distance between the first and second positions. Thereby, connection between the upper and lower needle sections 29, 31 is even further ensured.

According to the embodiments illustrated in FIG. 1, the injector body 7 is provided with at least one stop portion 41 extending into the second channel 26 in a radial direction Rd1 of the second channel 26. The upper needle section 29 comprises a protrusion 43 protruding in a radial direction Rd2 of the upper needle section 29. The protrusion 43 is arranged to abut against the at least one stop portion 41, to prevent movement of the upper needle section 29 out of the second channel 26, when the nozzle retainer 17 and the nozzle 9 are removed from the injector body 7 and when the injector body 7 is held in an upright position as is illustrated in FIG. 1. The upper needle section 29 is thereby retained in the second channel 26 in a simple and effective manner even when the nozzle retainer 17 and the nozzle 9 are removed from the injector body 7.

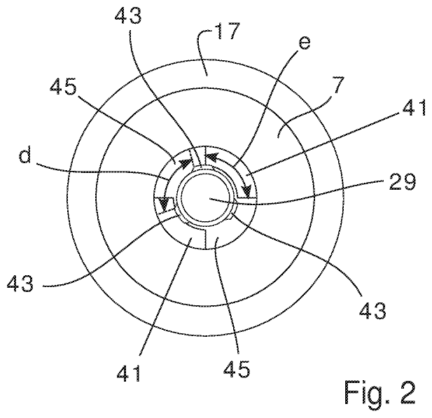

FIG. 2 illustrates a second cross section of the fuel injector 1 illustrated in FIG. 1. The second cross section illustrates the fuel injector 1 in a region of the stop portion 41 of the injector body 7. According to the illustrated embodiments, the injector body 7 is provided with two stop portions 41 and two gaps 45 provided between the at least two stop portions 41. The two gaps 45 each forms a fluid connection for fuel. Further, as can be seen in FIG. 1, the stop portions 41 are arranged at a position of the injector body 7 corresponding to a position of the boundary between the first channel 19 and the second channel 19. Thus, in the illustrated embodiments, the first and second channels are fluidically connected via the gaps 45 illustrated in FIG. 2.

According to the embodiments illustrated in FIG. 2, the upper needle section 29 comprises three protrusions 43 protruding in the radial direction of the upper needle section 29. Further, each stop portion 41 is provided with an extension e around a circumference of the second channel 26 exceeding a circumferential distance d between edges of the protrusions 43. Thereby, the upper needle section 29 is prevented from being displaced out of the injector body 7 regardless of the rotational position of the upper needle section 29 in relation to the injector body 7.

The upper needle section 29 may comprise another number of protrusions 43 than three. Likewise, the injector body 7 may be provided with another number of stop portions than two. As an example, the upper needle section 29 may comprise one annular protrusion protruding in the radial direction of the upper needle section 29 arranged to abut against at least one stop portion 41 of the injector body 7.

As a further example, the upper needle section 29 may comprise two protrusions protruding in the radial direction of the upper needle section 29 arranged to abut against at least one stop portion 41 of the injector body 7. In such embodiments, the two protrusions and the stop portions may be arranged such that each stop portion 41 is provided with an extension e around a circumference of the second channel 26 exceeding a circumferential distance d between edges of the two protrusions. In such embodiments, the injector body 7 may for example be provided with three stop portions.

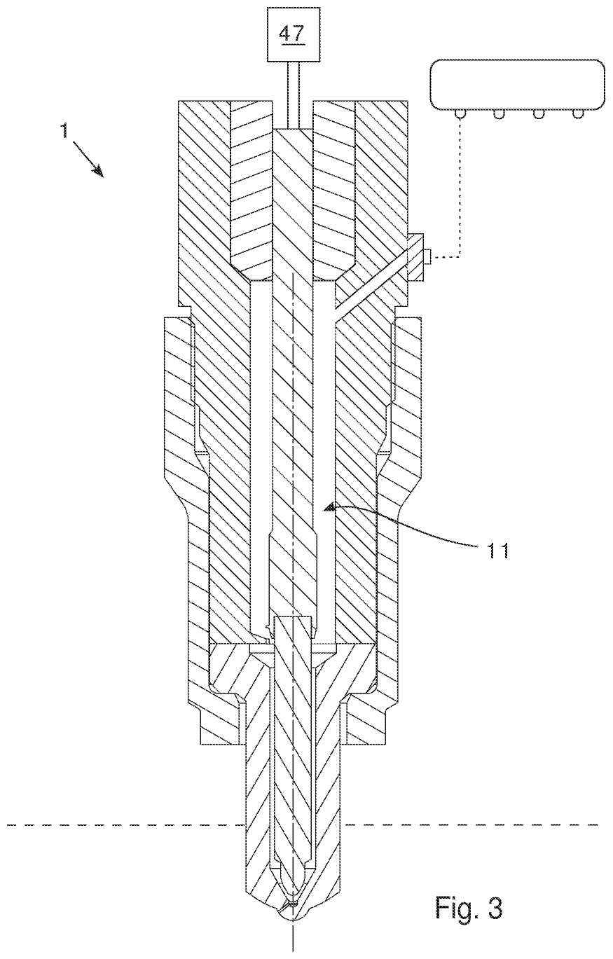

FIG. 3 illustrates a fuel injector 1 according to some further embodiments. According to the illustrated embodiments, the fuel injector 1 comprises an actuator 47 arranged to displace the needle 11 between the first and second positions. According to further embodiments, the actuator 47 is arranged to displace the needle 11 from the first position to the second position and wherein a biasing force, e.g. obtained by a spring or by fuel pressure, displaces the needle 11 from the second position to the first position. According to alternative further embodiments, the actuator 47 is arranged to displace the needle 11 from the second position to the first position and wherein a biasing force, e.g. obtained by a spring or by fuel pressure, displaces the needle 11 from the first position to the second position. The actuator 47 may comprise a piezoelectrical actuator. The fuel injector 1 illustrated in FIG. 3 comprises the corresponding features as the fuel injector 1 illustrated in FIG. 1, apart from the actuator 47, and absence of a connection channel and of a control chamber in fluid communication with a second end of the needle 11.

According to some embodiments, no mechanical connection between the actuator 47 and the needle exist. Instead, in such embodiments, the actuator 47 may be arranged to control fuel pressure in a control chamber, e.g. a control chamber 35 as is illustrated in FIG. 1, to displace the needle 11 between the first and second positions.

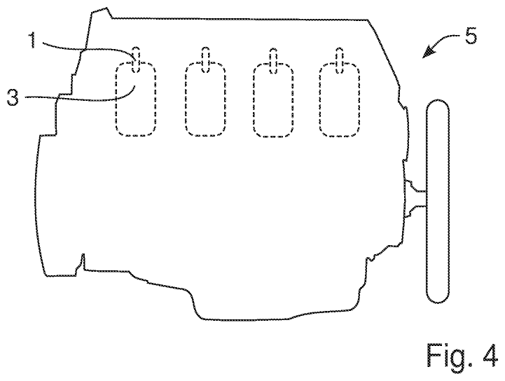

FIG. 4 illustrates an internal combustion engine 5 comprising a combustion chamber 3 and a fuel injector 1 according to some embodiments. The fuel injector 1 is configured to supply fuel into the combustion chamber 3. The internal combustion engine 5 may be a compression-ignition engine, such as a diesel engine for a manned or unmanned vehicle for land based propulsion such as a truck, lorry, construction vehicle, tractor, car etc. or for an industrial installation such as a generator set, or for a marine vessel. According to further embodiments, the internal combustion engine may be a spark-ignition engine for a manned or unmanned vehicle for land based propulsion such as a truck, lorry, construction vehicle, tractor, car etc. or for and industrial installation such as an generator set, or for a marine vessel.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the present invention, as defined by the appended claims.

As used herein, the term “comprising” or “comprises” is open-ended, and includes one or more stated features, elements, steps, components or functions but does not preclude the presence or addition of one or more other features, elements, steps, components, functions or groups thereof.

1. A fuel injector for supplying fuel into a combustion chamber of an internal combustion engine, wherein the fuel injector comprises:
an injector body;
a nozzle;
a needle comprising a needle tip at a first end of the needle; and
a nozzle retainer removably arranged at the injector body to retain the nozzle against the injector body, and wherein the nozzle comprises:
a first channel adapted to contain fuel;
nozzle openings extending from the first channel; and
a seat portion adjacent to the nozzle openings,
wherein the injector body comprises a second channel adapted to contain fuel, wherein the first and second channels are fluidically connected,
wherein the needle is slidably arranged in the first and second channels between a first position, in which the needle tip abuts the seat portion to close a fluid connection between the first channel and the nozzle openings, and a second position in which the needle tip is released from the seat portion to open the fluid connection between the first channel and the nozzle openings,
wherein the needle comprises an upper needle section and a lower needle section, and wherein the lower needle section comprises the needle tip,
wherein the lower needle section is removably connected to the upper needle section,
wherein the injector body is provided with at least one stop portion extending into the second channel, and
wherein the upper needle section comprises one or more protrusions protruding in a radial direction of the upper needle section, wherein the one or more protrusions are arranged to abut against the at least one stop portion, to prevent movement of the upper needle section out of the second channel, when the nozzle retainer and the nozzle are removed from the injector body.

2. The fuel injector according to claim 1, wherein at least a portion of the upper needle section extends through the second channel.

3. The fuel injector according to claim 1, wherein the lower needle section is connected to the upper needle section in at least one of the first and second channels.

4. The fuel injector to claim 1, further comprising a control chamber adapted to contain fuel, wherein a second end of the needle is in fluid communication with the control chamber, and wherein movement of the needle between the first and second positions is controlled by controlling a pressure difference between fuel pressure in the control chamber and fuel pressure in the first and second channels.

5. The fuel injector according to claim 4, wherein the second end of the needle forms a delimiting surface of the control chamber.

6. The fuel injector according to claim 1, wherein the at least one stop portion is provided with at least one gap forming a fluid connection for fuel.

7. The fuel injector according to claim 1, wherein the first and second channels are fluidically connected via the at least one gap.

8. The fuel injector according to claim 1, wherein the injector body is provided with at least two stop portions and at least two gaps provided between the at least two stop portions.

9. The fuel injector according to claim 1, wherein the upper needle section comprises two or more protrusions, and wherein the at least one stop portion is provided with an extension around a circumference of the second channel exceeding a circumferential distance between edges of the two or more protrusions.

10. The fuel injector according to claim 1, wherein the fuel injector is a common rail fuel injector and wherein the second channel is arranged to be fluidically connected to a pressurized fuel rail of a common rail fuel injection system.

11. The fuel injector according to claim 1, wherein the fuel injector comprises an actuator arranged to displace the needle between the first and the second position, and/or between the second and the first position.

12. A nozzle for a fuel injector for supplying fuel into a combustion chamber of an internal combustion engine, wherein the fuel injector comprises in addition to the nozzle:
an injector body;
a needle comprising a needle tip at a first end of the needle; and
a nozzle retainer removably arranged at the injector body to retain the nozzle against the injector body, and wherein the nozzle comprises:
a first channel adapted to contain fuel;
nozzle openings extending from the first channel; and
a seat portion adjacent to the nozzle openings,
wherein the injector body comprises a second channel adapted to contain fuel, wherein the first and second channels are fluidically connected,
wherein the needle is slidably arranged in the first and second channels between a first position, in which the needle tip abuts the seat portion to close a fluid connection between the first channel and the nozzle openings, and a second position in which the needle tip is released from the seat portion to open the fluid connection between the first channel and the nozzle openings,
wherein the needle comprises an upper needle section and a lower needle section, and wherein the lower needle section comprises the needle tip,
wherein the lower needle section is removably connected to the upper needle section,
wherein the injector body is provided with at least one stop portion extending into the second channel, and
wherein the upper needle section comprises one or more protrusions protruding in a radial direction of the upper needle section, wherein the one or more protrusions are arranged to abut against the at least one stop portion, to prevent movement of the upper needle section out of the second channel, when the nozzle retainer and the nozzle are removed from the injector body.

13. A lower needle for a fuel injector for supplying fuel into a combustion chamber of an internal combustion engine, wherein the fuel injector comprises in addition to the lower needle:
an injector body;
a nozzle;
a needle comprising a needle tip at a first end of the needle; and
a nozzle retainer removably arranged at the injector body to retain the nozzle against the injector body, and wherein the nozzle comprises:
a first channel adapted to contain fuel;
nozzle openings extending from the first channel; and
a seat portion adjacent to the nozzle openings,
wherein the injector body comprises a second channel adapted to contain fuel, wherein the first and second channels are fluidically connected,
wherein the needle is slidably arranged in the first and second channels between a first position, in which the needle tip abuts the seat portion to close a fluid connection between the first channel and the nozzle openings, and a second position in which the needle tip is released from the seat portion to open the fluid connection between the first channel and the nozzle openings,
wherein the needle comprises an upper needle section and the lower needle section, and wherein the lower needle section comprises the needle tip,
wherein the lower needle section is removably connected to the upper needle section,
wherein the injector body is provided with at least one stop portion extending into the second channel, and
wherein the upper needle section comprises one or more protrusions protruding in a radial direction of the upper needle section, wherein the one or more protrusions are arranged to abut against the at least one stop portion, to prevent movement of the upper needle section out of the second channel, when the nozzle retainer and the nozzle are removed from the injector body.

14. An internal combustion engine comprising at least one combustion chamber and a fuel injector, wherein the fuel injector is configured to supply fuel into the combustion chamber, and wherein the fuel injector comprises:
an injector body;
a nozzle;
a needle comprising a needle tip at a first end of the needle; and
a nozzle retainer removably arranged at the injector body to retain the nozzle against the injector body, and wherein the nozzle comprises:
a first channel adapted to contain fuel;
nozzle openings extending from the first channel; and
a seat portion adjacent to the nozzle openings,
wherein the injector body comprises a second channel adapted to contain fuel, wherein the first and second channels are fluidically connected,
wherein the needle is slidably arranged in the first and second channels between a first position, in which the needle tip abuts the seat portion to close a fluid connection between the first channel and the nozzle openings, and a second position in which the needle tip is released from the seat portion to open the fluid connection between the first channel and the nozzle openings,
wherein the needle comprises an upper needle section and a lower needle section, and wherein the lower needle section comprises the needle tip,
wherein the lower needle section is removably connected to the upper needle section,
wherein the injector body is provided with at least one stop portion extending into the second channel, and wherein the upper needle section comprises one or more protrusions protruding in a radial direction of the upper needle section, wherein the one or more protrusions are arranged to abut against the at least one stop portion, to prevent movement of the upper needle section out of the second channel, when the nozzle retainer and the nozzle are removed from the injector body.
